(19) United States
(12) Patent Application Publication
(10) Pub. No.: US 2015/0051845 A1
(43) Pub. Date: Feb. 19, 2015

(54) SMART RAZOR HANDLE

(71) Applicant: HANAN SHAREEF MOHAMMAD ALHASHEMI, AL-ANDALOUS (KW)

(72) Inventor: HANAN SHAREEF MOHAMMAD ALHASHEMI, AL-ANDALOUS (KW)

(73) Assignee: KALED AL-HASAN

(21) Appl. No.: 13/967,359

(22) Filed: Aug. 15, 2013

(51) Int. Cl. B26B 21/40

(52) U.S. Cl. CPC B26B 21/4056
USPC 702/34; 30/34.05

(57) ABSTRACT

Smart razor handle with scanner, pressure sensor, processing unit, memory, programming keys, and integrated screen is aimed to enhance performance, ease of use, and provide additional comfort to the user while using shaving cartridge. The smart handle provides the user with important information regarding the shaving cartridges through the integrated screen, and speaker.

### BACKGROUND OF THE INVENTION

1. Field of the Invention

The present invention relates to razors assembly and in particular to razor assemblies with replaceable razor cartridges.

2. Description of the Related Art

Disposable razors are razors in which the shaving cartridge, containing the blades is connected permanently to the razor handle to form a single unit. When the blades become dulled after certain number of uses, the whole razor is discarded. Disposable razors affect the environment since the entire unit including the cartridge and the handle are thrown away.

Razor assembly that has a removable or replaceable shaving cartridge and a durable handle is more convenient and has lower impact on the environment. In these razors, only the shaving cartridge, which is typically much smaller than the razor handle, is discarded after certain amount of uses when the blades become dulled. The razor handle is reused. These razors reduce the amount of disposable parts leading to a reduction in the environmental problems associated with waste.

U.S. Pat. No. 6,584,696 discloses a razor unit with a razor head assembled with a handle. The handle has attachment comprising of at least one prong extending outwards from the handle. The razor head has a chamber that receives the attachment means of the handle.

US. Pat. No. 2003/0079348 discloses a razor assembly that includes a handle, a replaceable cartridge, one or more clip members, and a rigid pivot member which is attached to the handle. The replaceable cartridge includes a frame and one or more razor blades. The replaceable cartridge can be detached from the pivot member to enable replacement by the user.

US. Pat. No. 2009/0056140 discloses a razor with a replaceable shaving cartridge that includes a pivotal frame, a blade unit, and an interconnect member. The blade unit has a camming surface and includes one or more blades.

US. Pat. No. 2010/0095530 discloses a razor which includes a container for a shaving cream, at least one razor blade, and an electrically powered actuating mechanism, to cause the shaving composition from the container to be discharged from the shaving head.

U.S. Pat. No. 7,810,243 discloses razor handles for razors having a battery-powered functionality. The handle includes a unitary grip portion to receive a razor head at one end, and a battery cover, mounted on the grip portion. When joint, the grip portion and the battery cover define a water-tight unit.

While razors with removal sod replaceable cartridges are widely popular and environmentally friendly, they have several disadvantages. Additional features can be added to these razors to enhance the performance, ease of use, and provide additional comfort to the user.

### SUMMARY OF THE INVENTION

As used herein, the term “shaving cartridge” refers to a single replaceable shaving cartridge while the term “cartridge package” is meant to include a set of several shaving cartridges.

When the user buys a new package containing several replaceable shaving cartridges, he has no means of assigning a specific shaving cartridge to a specific part of the body. If different users use the same razor handle, they cannot assign a particular shaving cartridge or package to a particular user. Furthermore, the user cannot determine the date of first use of the shaving cartridge. He might overuse the shaving cartridge with dull blades leading to cuts, shaving rash, and razor burn and bumps. On the other hand, the user might discard the shaving cartridge too early while it is still sharp and thus waste money.

What is needed therefore is a smart razor handle that can be used in every razor assembly with removable or replaceable shaving cartridges. The smart razor handle provides the user with all information regarding the shaving cartridge or package being used to optimize comfort, performance, and reduce discomfort resulting from overuse of shaving cartridges and money waste resulting from underuse.

The present invention features a smart razor handle with a processing unit, memory, a scanner, and a pressure sensor. The scanner is able to read a barcode or colored label on the shaving cartridge. Each shaving cartridge in the cartridge package has a unique barcode or colored label. When the shaving cartridge is attached to the smart handle, the scanner identifies that specific cartridge and enables the user to enter required information or read stored information about this cartridge.

The smart handle also includes a speaker that alerts the user when the shaving cartridge has exceeded the total shaving time recommended by the manufacture, or if the battery of the smart handle needs to be recharged. Furthermore, the smart handle has programming keys that enable the user to enter various information regarding the shaving cartridge.

The smart handle reduces cuts, razor burns, bumps, and shaving rash resulting from overuse of shaving cartridges by warning the user when the shaving cartridge has been used for more than the total recommended shaving time or when it has been unused for too long and hence needs to be replaced. In addition, the smart razor handle is more economical since it enables more than one user to share the same handle.

### BRIEF DESCRIPTION OF THE DRAWINGS

FIG. 1 is a front view of the razor assembly with the smart handle.

FIG. 2 is a projection of possible functions on the integrated screen of the smart handle

FIG. 3 is a perspective view of a the razor assembly with the smart razor handle

Similar reference characters denote corresponding features consistently throughout the attached drawings.

### DETAILED DESCRIPTION OF THE PREFERRED EMBODIMENTS

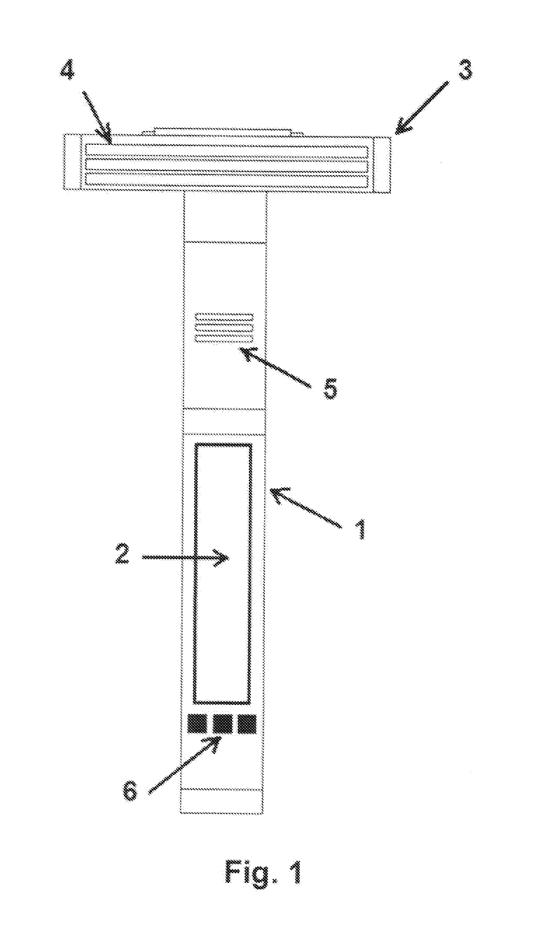

Referring to the invention in more details, in FIG. 1 there is shown a razor assembly with a replaceable shaving cartridge 3 containing three shaving blades 4. The shaving cartridge 3 is attached to the smart handle 1. The smart handle 1 has an integrated screen 2 that provides the user with useful information regarding the shaving cartridge 3 currently used. The smart handle 1 also includes a speaker 5 that alerts the user when the shaving cartridge 3 has exceeded the total shaving time recommended by the manufacture, or if the battery of the smart handle 1 needs to be recharged. The programming keys 6 on the smart handle 1 enable the user to enter various information regarding the replaceable shaving cartridge 3 or the cartridge package if required.

The smart handle 1 has a processing unit, memory, and sensors (not shown in figures), thus it is able to store and process data about each shaving cartridge 3. The smart handle 1 provides the user with important information regarding the shaving cartridges through the integrated screen 2 and speaker 5. Furthermore, the smart handle 1 can connect remotely to other smart devices via Bluetooth, near field communication, . . . etc, and provide statistics about the shaving cartridges 3. Applications on these smart devices interpret this data and alarm the user when he needs to purchase a new cartridge package.

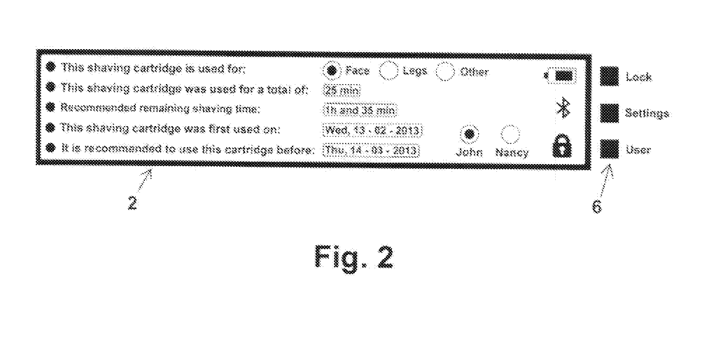

FIG. 2 illustrates a projection of possible functions on the integrated screen 2 of the smart handle 1. As shown in FIG. 2, the integrated screen enables the user to assign different shaving cartridges 3 to different parts of the body. The integrated screen in FIG. 2 shows that the current shaving cartridge 3 attached is assigned to shave the face not the legs. Furthermore, the integrated screen 2 informs the user of the total shaving time the shaving cartridge 3 was used for, the recommended remaining time of usage, and the recommended date to discard of this shaving cartridge 3.

The integrated screen 2 also informs the user if the replaceable shaving cartridge 3 belongs to another user. As shown in the FIG. 2, the shaving cartridge 3 being used belongs to John not Nancy. In addition, the integrated screen 2 shows the current charge of the battery, and whether the Bluetooth is currently activated or not.

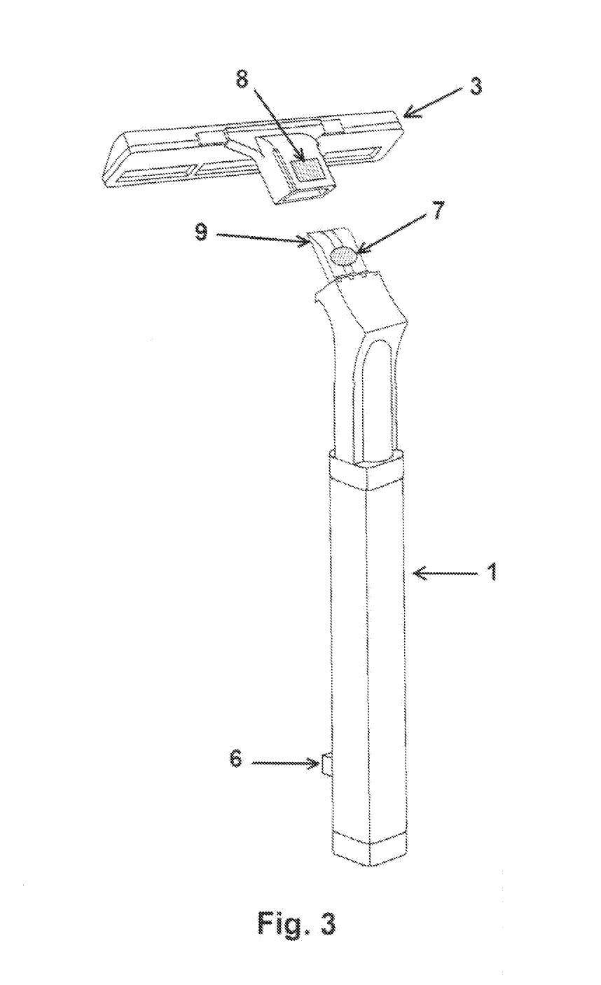

Referring now to FIG. 3 there is shown a scanner 7 and a pressure sensor 9 at the upper section of the smart handle 1. The scanner is able to read a barcode 8 or colored label 8 on the shaving cartridge 3. Each shaving cartridge 3 in the cartridge package has a unique barcode or colored label 8. When the shaving cartridge 3 is attached to the smart handle 1, the scanner 7 identifies that specific cartridge and enables the user to enter required information about this cartridge 3 if it was the first time being used. The user can also check the information about previous usage if the shaving cartridge 3 was used before.

A particular shaving cartridge 3 through its unique barcode can be assigned to a particular user as well as a particular part of the body. In addition, a barcode can also be added to the cartridge package to assign all the shaving cartridges 3 in the package to a specific user.

The pressure sensor 9 shown in FIG. 3 identities the pressure exerted on the shaving cartridge 3 as it is being used. The pressure sensor 9 enables the smart handle 1 to estimate the total shaving time of each cartridge and convey this information to the user.

The smart razor handle 1 with the scanner 7, pressure sensor 9, processing unit, memory, programming keys 6, and integrated screen 2 is aimed to enhance performance, ease of use, and provide additional comfort to the user. Though the smart handle 1 might be more expensive that normal razor handles, the increase in the price balances with the extra features and advantages it provides.

The smart razor handle 1 is more economical since it enables more than one user to share the same handle 1. Each cartridge in a package or the entire package can be assigned to a specific user. Furthermore, the smart handle 1 enables the user to specify which body part each cartridge 3 is dedicated to. In addition, the smart handle will give specific information about the recommended total shaving interval for each cartridge 3 and prevents the user from throwing usable cartridges.

The smart handle reduces cuts, razor burns, bumps, and shaving rash resulting from overuse of shaving cartridges 3 by warning the user when the shaving cartridge 3 has been used for more than the total recommended shaving time or when it has been unused for too long and hence needs to be replaced.

A humidity sensor can also be integrated within the smart handle 1 to give more accurate projections of the recommended usage time of the shaving cartridges depending on the conditions the shaving cartridge 3 is stored at.

Those skilled in the art will appreciate that the shaving cartridge 3 and the smart handle 1 maybe of various configurations, i.e., the shaving cartridge 3 and handle 1 may be of different shape, the shaving cartridge 3 may contain one or more blades, and that the placement of the barcode or colored label 8, scanner 7, pressure sensor 9, the placement of the integrated screen 2, projected functions, programming keys 6, speaker 5, and battery, may vary.

The functions and features provided by the smart razor handle 1 can be integrated with and added to any of the traditional razors including those having a container for a shaving composition or an electrically powered actuating mechanism.

It is to be understood that the present invention is not limited to the embodiments described above, but encompasses any and all embodiments within the scope of the following claims.

1. Razor assembly comprising:
A replaceable shaving cartridge has multi-shaving blades;
Smart handle attached to the shaving cartridge, wherein the said smart handle has a processing unit, memory, pressure sensor in the top head of the smart handle to identify the pressure exerted on the shaving cartridge as it is being used, integrated screen to provide users with useful information regarding the shaving cartridge currently used, speaker as sound alert or battery recharge indicator, programming keys to enable the user to enter various information regarding the replaceable shaving cartridge and scanner to read a unique barcode or colored label on the shaving cartridge.

2. According to claim 1, the smart handle can connect remotely to other smart devices via Bluetooth, near field communication.

3. According to claim 1, smart phone application interprets the provided statistics about the shaving cartridges and alarms the user when he needs to purchase a new cartridge package.

4. According to claim 1, the integrated screen of the smart handle enables the user to assign different shaving cartridges to different parts of the body, shows that the current shaving cartridge attached is assigned to shave the face not the legs, and informs the user of the total shaving time the shaving cartridge was used for the recommended remaining time of usage, and the recommended date to discard of this shaving cartridge.

5. Smart razor handle attached to a replaceable shaving cartridge, wherein the said smart razor handle comprises scanner, pressure sensor, humidity sensor integrated within the smart handle, processing unit, memory, programming keys, and integrated screen.

6. According to claim 5, integrated screen of the smart handle enables the user to assign different shaving cartridges to different parts of the body, shows that the current shaving cartridge attached is assigned to shave the face not the legs, and informs the user of the total shaving time the shaving cartridge was used for, the recommended remaining time of usage, and the recommended date to discard of this shaving cartridge.

7. According to claim 5 the said integrated screen informs the user if the replaceable shaving cartridge belongs to another user, shows the current charge of the battery, and whether the Bluetooth is currently activated or not.

8. Method for provides the user with all information regarding the shaving cartridge or package being used to optimize comfort, performance, and reduce discomfort resulting from overuse of shaving cartridges by attaching smart razor handle to the shaving cartridge, wherein the said smart razor handle comprises:
scanner to read a unique barcode or colored label on the shaving cartridge;
processing unit, memory to store and process data about each shaving cartridge and provides the user with important information regarding the shaving cartridges through the integrated screen, and speaker;
speaker that alerts the user when the shaving cartridge has exceeded the total shaving time recommended by the manufacture, or if the battery of the smart handle needs to be recharged. Furthermore;
programming keys that enable the user to enter various information regarding the shaving cartridge;
pressure sensor to identify the pressure exerted on the shaving cartridge as it is being used, wherein the pressure sensor enables the smart handle to estimate the total shaving time of each cartridge and convey this information to the user;
A humidity sensor can also be integrated within the smart handle to give more accurate projections of the recommended usage time of the shaving cartridges depending on the conditions the shaving cartridge is stored at.

9. According to claim 8, integrated screen of the smart handle enables the user to assign different shaving cartridges to different parts of the body, shows that the current shaving cartridge attached is assigned to shave the face not the legs, and informs the user of the total shaving time the shaving cartridge was used for, the recommended remaining time of usage, and the recommended date to discard of this shaving cartridge.

10. According to claim 8 the said integrated screen informs the user if the replaceable shaving cartridge belongs to another user, shows the current charge of the battery, and whether the Bluetooth is currently activated or not.
